(19) United States
(12) Patent Application Publication
(10) Pub. No.: US 2026/0163264 A1
(43) Pub. Date: Jun. 11, 2026

(54) TERMINAL BLOCK

(71) Applicant: Yazaki Corporation, Tokyo (JP)

(72) Inventors: Yasuhiro TANAKA, Shizuoka (JP); Yasuhiro Otsuta, Shizuoka (JP); Sota Arai, Shizuoka (JP); Masatoshi Yamada, Shizuoka (JP); Yusuke Tsutagawa, Shizuoka (JP); Katsuya Nakano, Shizuoka (JP)

(73) Assignee: Yazaki Corporation, Tokyo (JP)

(21) Appl. No.: 19/181,485

(22) Filed: Apr. 17, 2025

(30) Foreign Application Priority Data
May 20, 2024 (JP) 2024-081665

(51) Int. Cl. H01R 9/24; H01R 4/30; H01R 4/34

(52) U.S. Cl. CPC H01R 9/24; H01R 4/302; H01R 4/34

(57) ABSTRACT

A terminal block includes a bus bar including a through hole, a nut including a screw hole, a housing including a holding portion that holds the bus bar and a recess that holds the nut with the screw hole caused to face the through hole, and a bolt screwed in the nut housed in the recess. A shape of the nut is a rectangle having a long side and a short side when viewed from a direction of a center axis of the screw hole. The screw hole is disposed to be shifted to one side along a direction of the long side with respect to the center of the nut. The recess includes a locking surface that faces the long side and restricts rotation of the nut.

### CROSS-REFERENCE TO RELATED APPLICATION(S)

The present application claims priority to and incorporates by reference the entire contents of Japanese Patent Application No. 2024-081665 filed in Japan on May 20, 2024.

### BACKGROUND OF THE INVENTION

### 1. Field of the Invention

The present invention relates to a terminal block.

### 2. Description of the Related Art

There has been a technique of co-fastening two conductive members with a nut and a bolt. JP 2021-089 881 A discloses a housing including a nut holding portion that holds a nut. A terminal portion of a conductor held by the housing is co-fastened with a mating terminal by a bolt and a nut.

When the bolt is screwed in the nut, the housing comes into contact with the nut and restricts rotation of the nut. At this time, if a load applied to the housing from the nut is large, it is necessary to increase the thickness of the housing, causing an increase in the size of the housing.

### SUMMARY OF THE INVENTION

An object of the present invention is to provide a terminal block capable of reducing a load applied to a housing from a nut.

In order to achieve the above mentioned object, a terminal block according to one aspect of the present invention includes a bus bar including a through hole; a nut including a screw hole; a housing including a holding portion that holds the bus bar, and a recess that holds the nut with the screw hole and the through hole caused to face each other; and a bolt screwed in the nut housed in the recess, wherein a shape of the nut is a rectangle having a long side and a short side when viewed from a direction of a center axis of the screw hole, the screw hole is disposed to be shifted to one side along a direction of the long side with respect to a center of the nut, and the recess includes a locking surface that faces the long side and restricts rotation of the nut.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminal block according to an embodiment;

FIG. 2 is an exploded perspective view illustrating the terminal block according to the embodiment;

FIG. 3 is a perspective view illustrating a housing according to the embodiment;

FIG. 4 is a front view illustrating the housing according to the embodiment;

FIG. 5 is a cross-sectional view illustrating the housing according to the embodiment;

FIG. 6 is a plan view illustrating a nut according to the embodiment;

FIG. 7 is a perspective view illustrating the nut according to the embodiment;

FIG. 8 is a front view illustrating the housing holding the nut;

FIG. 9 is a cross-sectional view illustrating the housing holding the nut;

FIG. 10 is a cross-sectional view illustrating the terminal block according to the embodiment;

FIG. 11 is a cross-sectional view illustrating the terminal block according to the embodiment;

FIG. 12 is a cross-sectional view illustrating the terminal block according to the embodiment; and

FIG. 13 is a cross-sectional view illustrating the terminal block according to the embodiment.

### DETAILED DESCRIPTION OF THE PREFERRED EMBODIMENTS

A terminal block according to an embodiment of the present invention is explained in detail below with reference to the drawings. Note that the present invention is not limited by the embodiment. Components in the embodiment explained below include components that can be easily assumed by those skilled in the art or components that are substantially the same.

### Embodiment

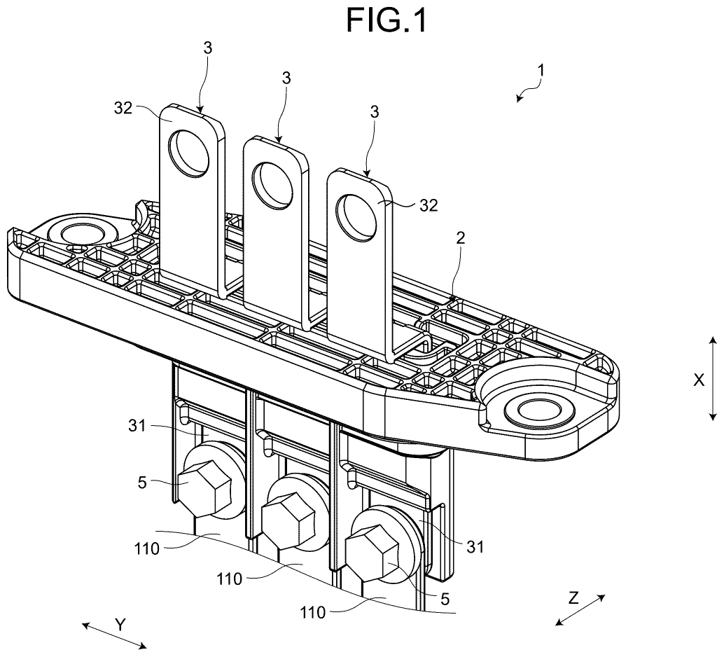

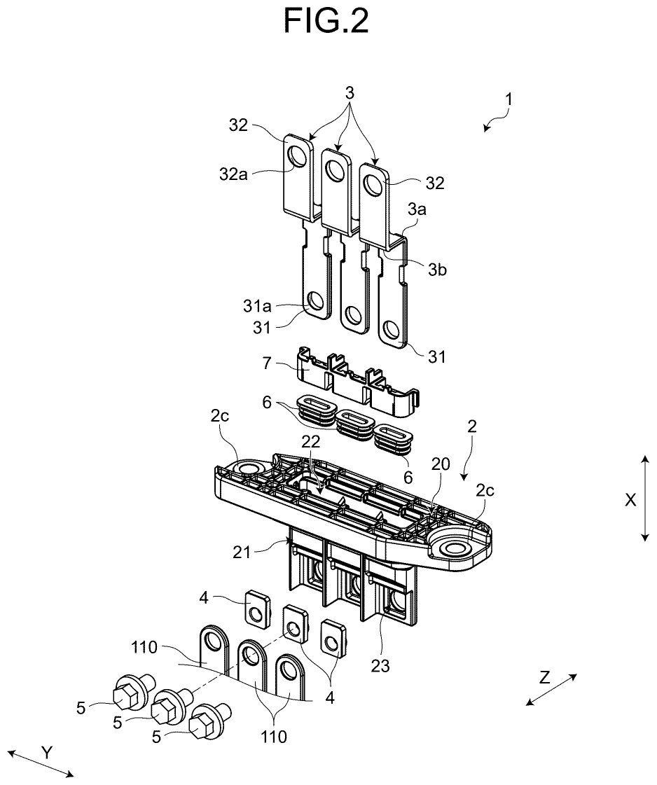

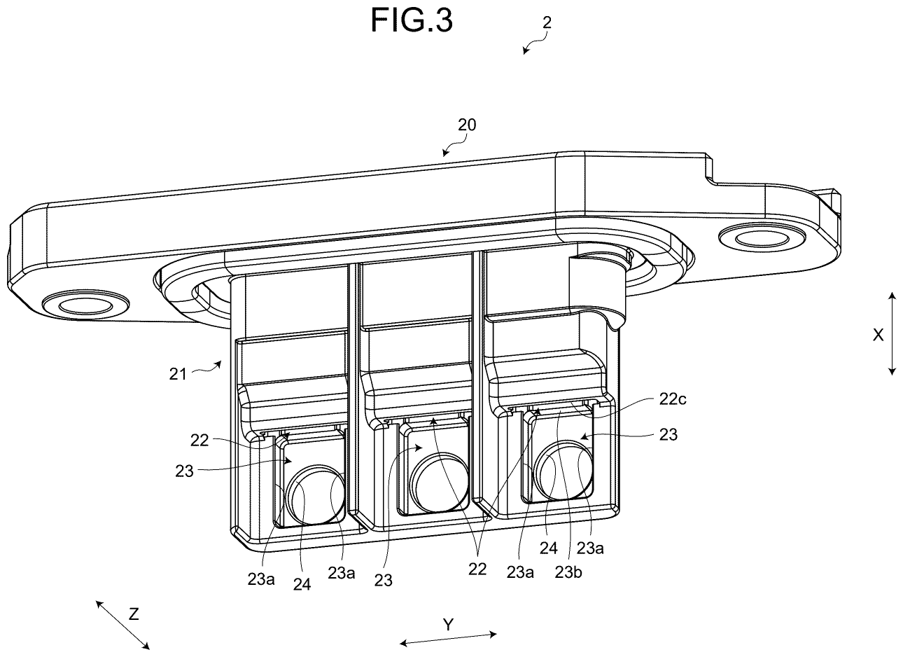

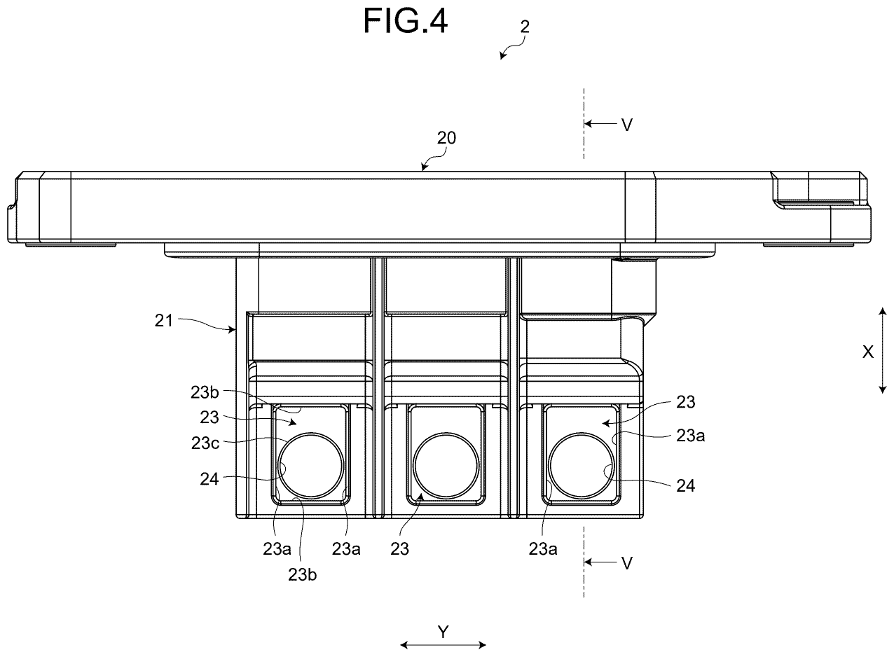

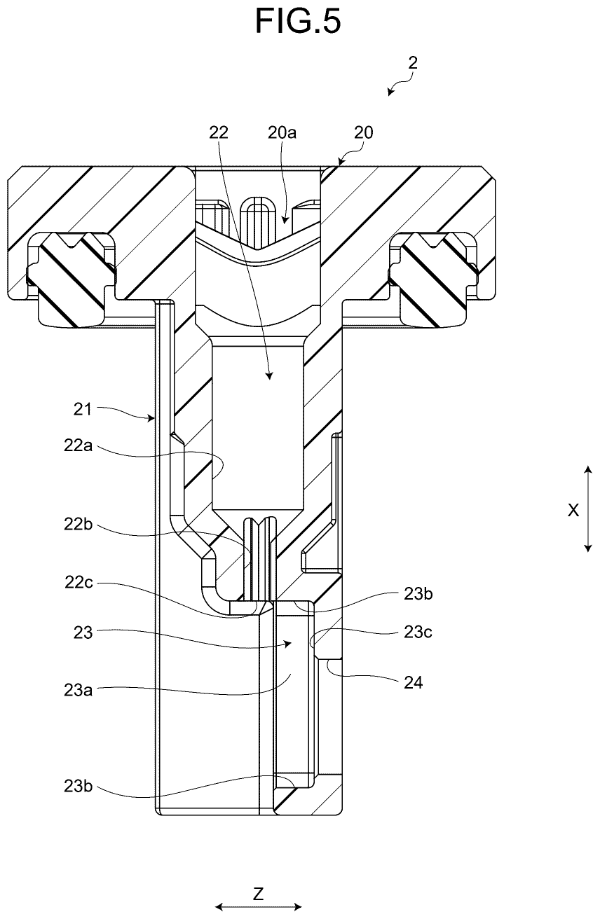

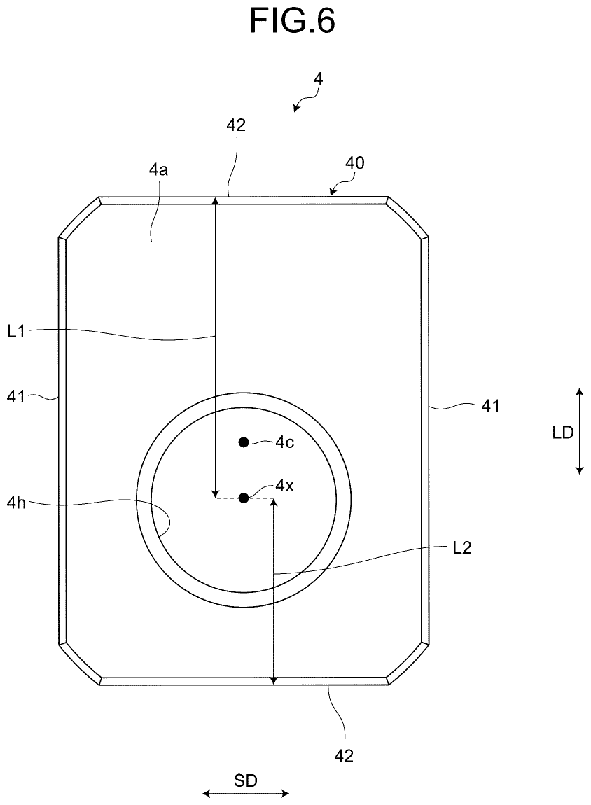

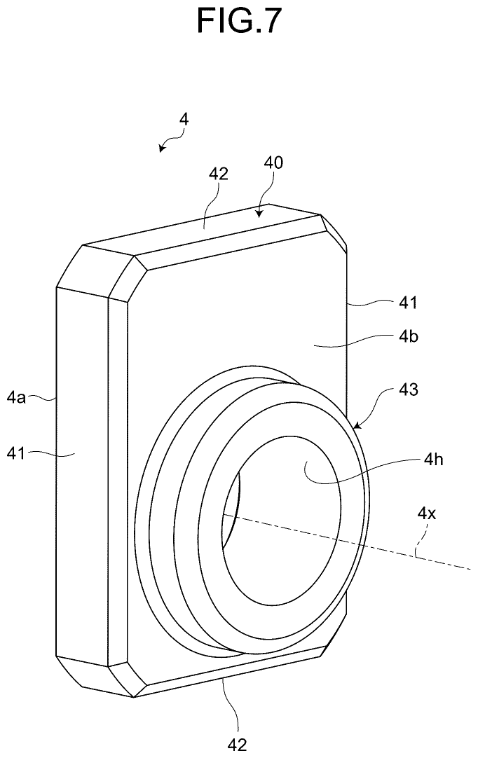

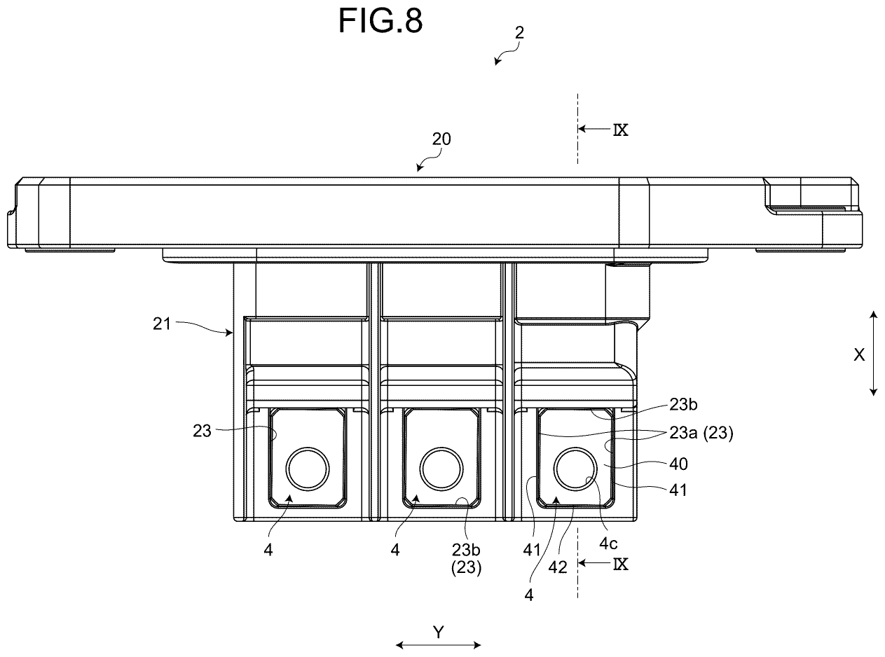

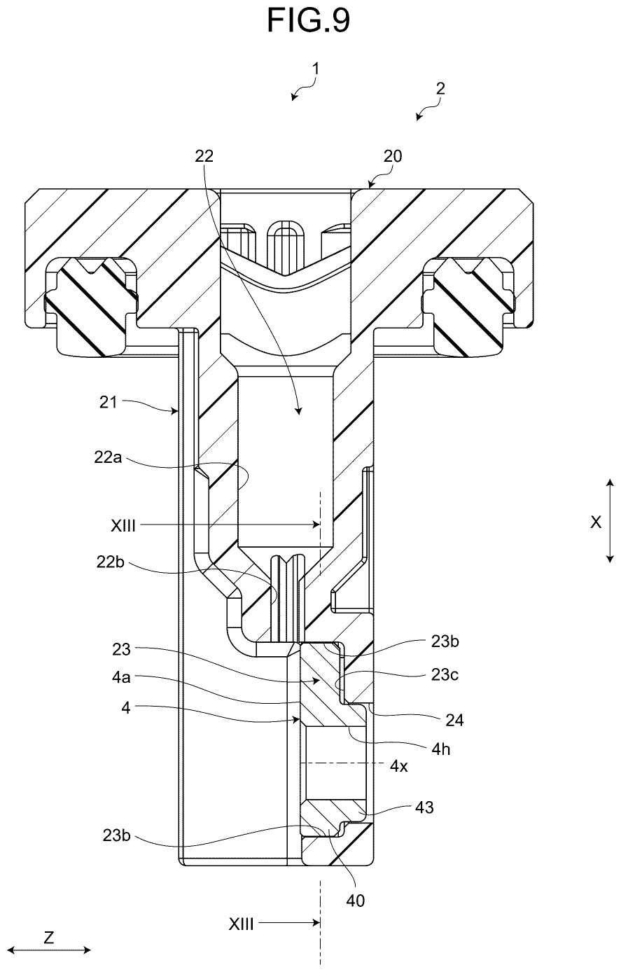

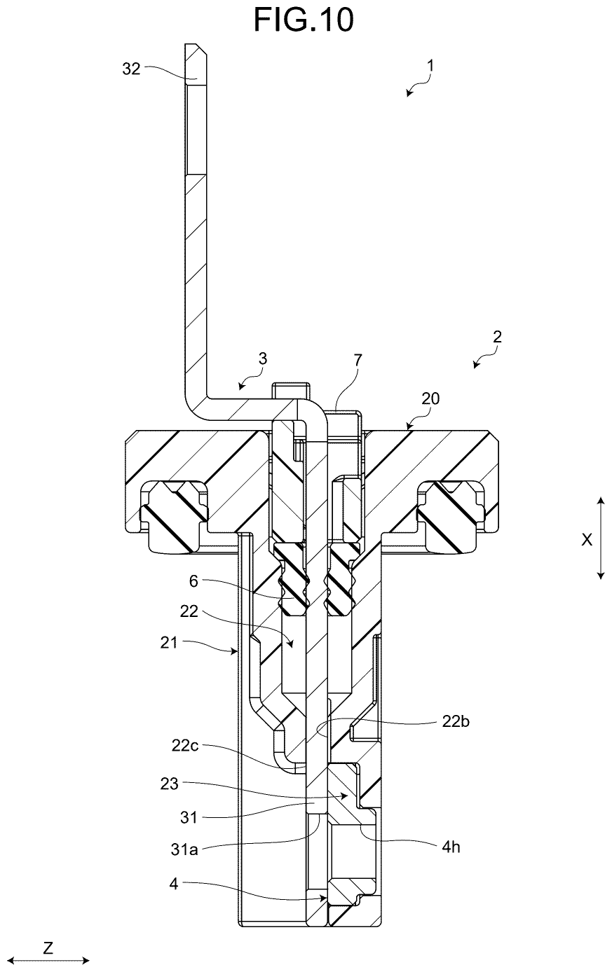

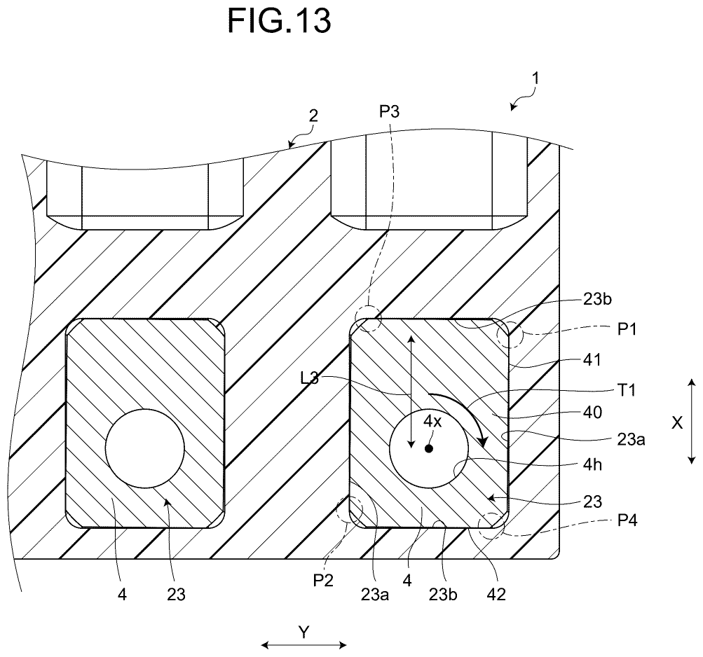

An embodiment is explained with reference to FIGS. 1 to 13. The present embodiment relates to a terminal block. FIG. 1 is a perspective view illustrating a terminal block according to an embodiment, FIG. 2 is an exploded perspective view illustrating the terminal block according to the embodiment, FIG. 3 is a perspective view illustrating a housing according to the embodiment, FIG. 4 is a front view illustrating the housing according to the embodiment, FIG. 5 is a cross-sectional view illustrating the housing according to the embodiment, FIG. 6 is a plan view illustrating a nut according to the embodiment, FIG. 7 is a perspective view illustrating the nut according to the embodiment, FIG. 8 is a front view illustrating the housing holding the nut, FIG. 9 is a cross-sectional view illustrating the housing holding the nut, and FIGS. 10 to 13 are cross-sectional views of the terminal block according to the embodiment. In FIG. 5, a V-V cross section of FIG. 4 is illustrated. In FIG. 9, a IX-IX cross section of FIG. 8 is illustrated. In FIG. 13, a XIII-XIII cross section of FIG. 9 is illustrated.

As illustrated in FIG. 1, a terminal block 1 in the present embodiment includes a housing 2 and three bus bars 3. The bus bar 3 electrically connects, for example, a first device and a second device. The two devices may be a motor and an inverter mounted on a vehicle. The housing 2 is fixed to, for example, a housing of the first device. A first terminal portion 31 of the bus bar 3 is connected to a terminal 110 of the first device.

As illustrated in FIG. 2, the terminal block 1 includes a nut 4 held by the housing 2 and a bolt 5 screwed in the nut 4. The bus bar 3 and the terminal 110 are fastened by the nut 4 and the bolt 5. The terminal block 1 in the present embodiment is configured to be able to reduce a load on the housing 2 at the time when the bolt 5 is screwed in the nut 4.

The bus bar 3 is formed of a metal plate having conductivity. As illustrated in FIG. 2, each of the bus bars 3 includes a first terminal portion 31 and a second terminal portion 32. The first terminal portion 31 is one end portion in the longitudinal direction in the bus bar 3. The second terminal portion 32 is another end portion in the longitudinal direction in the bus bar 3. Both of the first terminal portion 31 and the second terminal portion 32 has a flat plate shape. Circular through holes 31a and 32a are provided in the first terminal portion 31 and the second terminal portion 32.

The bus bar 3 includes bent portions 3a and 3b formed between the first terminal portion 31 and the second terminal portion 32. The bus bar 3 is bent at a right angle at each of the two bent portions 3a and 3b. The two bent portions 3a and 3b are formed such that the two terminal portions 31 and 32 protrude in opposite directions. The first terminal portion 31 is connected to the terminal 110 of the first device and the second terminal portion 32 is connected to a terminal or the like of the second device.

The housing 2 is a member including a holding portion for holding the bus bar 3 and a recess 23 for holding the nut 4. The housing 2 is molded from, for example, insulative synthetic resin. The housing 2 includes a main body 20 and a support wall 21. The main body 20 is a portion fixed to the first device and has a substantially flat plate shape. Collars 2c made of metal are disposed at both end portions of the main body 20. The housing 2 is fixed to the first device by bolts inserted through the collars 2c.

The support wall 21 is erected from the main body 20 in the thickness direction of the main body 20. A plurality of bus bars 3 are inserted into the housing 2 to pierce through the main body 20 and the support wall 21. The housing 2 holds the plurality of bus bars 3 side by side. In the present specification, a direction in which the bus bars 3 are inserted into the housing 2 is referred to as first direction X and an arrangement direction of the plurality of bus bars 3 in the housing 2 is referred to as second direction Y. A direction orthogonal to both of the first direction X and the second direction Y is referred to as third direction Z. The third direction Z is a thickness direction of the bus bars 3 held by the housing 2. The bolt 5 is screwed in, in the third direction Z, the nut 4 held by the housing 2.

As illustrated in FIG. 3, the support wall 21 protrudes from the main body 20 in the first direction X. The width direction of the support wall 21 is the second direction Y and the thickness direction of the support wall 21 is the third direction Z. As illustrated in FIGS. 3 and 4, the shape of the support wall 21 when viewed from the third direction Z is a substantial rectangle.

As illustrated in FIG. 3, three through holes 22 and three recesses 23 are provided in the support wall 21. The three through holes 22 and the three recesses 23 are disposed at intervals in the second direction Y. The three through holes 22 are opened to a recess 20a of the main body 20.

As illustrated in FIG. 5, the through hole 22 pierces through the housing 2 in the first direction X. One end of the through hole 22 is opened to the recess 20a of the main body 20. The recess 20a is opened toward a side opposite to the side of the support wall 21 side. The through hole 22 includes a housing portion 22a and a holding portion 22b. The housing portion 22a is a portion that houses a gasket 6 attached to the bus bar 3. As illustrated in FIG. 2, a holder 7 and an annular gasket 6 are mounted on the bus bar 3. The plurality of bus bars 3 are inserted into one holder 7. The holder 7 holds three bus bars 3 side by side.

The gasket 6 is disposed between the first terminal portion 31 and the holder 7. A bus bar unit including the bus bar 3, the holder 7, and the gasket 6 is inserted into the housing 2 with the first terminal portion 31 set as a head. At this time, the holder 7 is housed in the recess 20a of the main body 20 while supporting an end face of the gasket 6 and the gasket 6 is inserted into the housing portion 22a. The gasket 6 seals a space between a wall surface of the housing portion 22a and the bus bar 3.

The holding portion 22b illustrated in FIG. 5 is a portion that holds the bus bar 3. Each of the bus bars 3 is held by the holding portion 22b corresponding to the bus bar 3. The bus bar 3 may be press-fit into the holding portion 22b. The holding portion 22b includes, for example, a rib for holding the bus bar 3. In this case, the rib protrudes in the third direction Z from the inner wall surface of the holding portion 22b. The rib for holding the bus bar 3 may be a crushing rib.

As illustrated in FIGS. 3 to 5, the recess 23 is disposed at the distal end in the first direction X in the support wall 21. In other words, the recess 23 is disposed at the end portion on a side far from the main body 20 in the support wall 21. The housing 2 in the present embodiment includes three recesses 23 arranged in the second direction Y. The recess 23 is opened in the third direction Z. The shape of the recess 23 when viewed from the third direction Z is a rectangle having a long side in the first direction X.

The recess 23 includes a pair of locking surfaces 23a, a pair of facing surfaces 23b, and one bottom surface 23c. The pair of locking surfaces 23a and the pair of facing surfaces 23b form a rectangular frame that houses the nut 4. The pair of locking surfaces 23a faces each other in the second direction Y. The pair of facing surfaces 23b faces each other in the first direction X. The locking surface 23a is a long side of the rectangular frame and the facing surface 23b is a short side of the rectangular frame. The locking surface 23a and the facing surface 23b face the side surface of the nut 4. The bottom surface 23c is a surface that supports the end face of the nut 4 inserted into the recess 23. The bottom surface 23c is connected to the locking surface 23a and the facing surface 23b and forms a bottom surface of a housing chamber that houses the nut 4.

In the support wall 21, a housing hole 24 connected to the recess 23 is provided. The housing hole 24 is opened to the bottom surface 23c of the recess 23 and pierces through the support wall 21 in the third direction Z. The cross-sectional shape of the housing hole 24 on a surface orthogonal to the third direction Z is a circle. The housing hole 24 is disposed further on the distal end side of the support wall 21 than the center of the recess 23. That is, the housing hole 24 is disposed to be shifted to a side far from the main body 20 with respect to the central position of the recess 23 in the first direction X.

As illustrated in FIGS. 3 and 5, the through hole 22 includes an opening 22c. The first terminal portion 31 of the bus bar 3 protrudes from the opening 22c to an external space. The opening 22c is disposed adjacent to one facing surface 23b of the recess 23. The first terminal portion 31 protruding from the opening 22c faces the bottom surface 23c of the recess 23 in the third direction Z.

As illustrated in FIGS. 6 and 7, the shape of the nut 4 in the present embodiment is a rectangle. More specifically, as illustrated in FIG. 7, the nut 4 includes a rectangular main body 40 and a rectangular protruding portion 43. The main body 40 has a substantially rectangular parallelepiped shape. The nut 4 includes a screw hole 4h piercing through the main body 40 and the protruding portion 43.

The shape of the main body 40 when viewed from the direction of a center axis 4x of the screw hole 4h is a rectangle having a long side 41 and a short side 42. Four corners of the main body 40 have a chamfered shape. The main body 40 includes a front surface 4a and a rear surface 4b. The front surface 4a is one of two main surfaces of the main body 40. The front surface 4a faces the bus bar 3 and a mating terminal 110. The rear surface 4b is another one of the two main surfaces of the main body 40. The rear surface 4b faces the bottom surface 23c of the recess 23.

As illustrated in FIG. 6, the main body 40 of the nut 4 has a longitudinal direction LD that is the direction of the long side 41 and a latitudinal direction SD that is the direction of the short side 42. The longitudinal direction LD and the latitudinal direction SD are orthogonal to each other. The screw hole 4h is disposed to be shifted to one side in the longitudinal direction LD with respect to the center 4c of the main body 40. The center 4c of the nut 4 is a central position of the main body 40 in the longitudinal direction LD and the latitudinal direction SD. The center axis 4x of the screw hole 4h is shifted in the longitudinal direction LD with respect to the center 4c. That is, in the longitudinal direction LD, a distance L1 from the center axis 4x to one short side 42 is longer than a distance L2 from the center axis 4x to the other short side 42.

As illustrated in FIG. 7, the protruding portion 43 has a cylindrical shape. The protruding portion 43 protrudes from the rear surface 4b of the nut 4. The protruding portion 43 is disposed concentrically with the center axis 4x of the screw hole 4h. A screw groove corresponding to the bolt 5 is formed on the inner circumferential surface of the protruding portion 43. That is, the screw hole 4h is formed in both of the main body 40 and the protruding portion 43.

As illustrated in FIGS. 8 and 9, the nut 4 is housed in the recess 23 of the housing 2. The nut 4 is inserted into the recess 23 to cause the long side 41 of the main body 40 to face the locking surface 23a of the recess 23. The short side 42 of the main body 40 faces the facing surface 23b of the recess 23. The main body 40 may be press-fit into the recess 23.

As illustrated in FIG. 9, the protruding portion 43 of the nut 4 is inserted into the housing hole 24 of the support wall 21. In the terminal block 1 in the present embodiment, erroneous assembly of the nut 4 is suppressed. When the nut 4 is inserted into the recess 23 in an inverted state, the front surface 4a of the nut 4 faces the bottom surface 23c of the recess 23. In this case, the protruding portion 43 protrudes to the outer side from the recess 23. As a result, when the bus bar 3 is inserted into the through hole 22, the protruding portion 43 interferes with the bus bar 3, whereby erroneous assembly of the nut 4 is detected.

FIG. 10 illustrates the bus bar 3 held by the housing 2. The holding portion 22b of the housing 2 holds the bus bar 3. The holder 7 is inserted into the recess of the main body 20 and positions the bus bar 3 in the first direction X. The first terminal portion 31 of the bus bar 3 faces the nut 4 and the recess 23 in the third direction Z. The through hole 31a of the first terminal portion 31 faces the screw hole 4h of the nut 4.

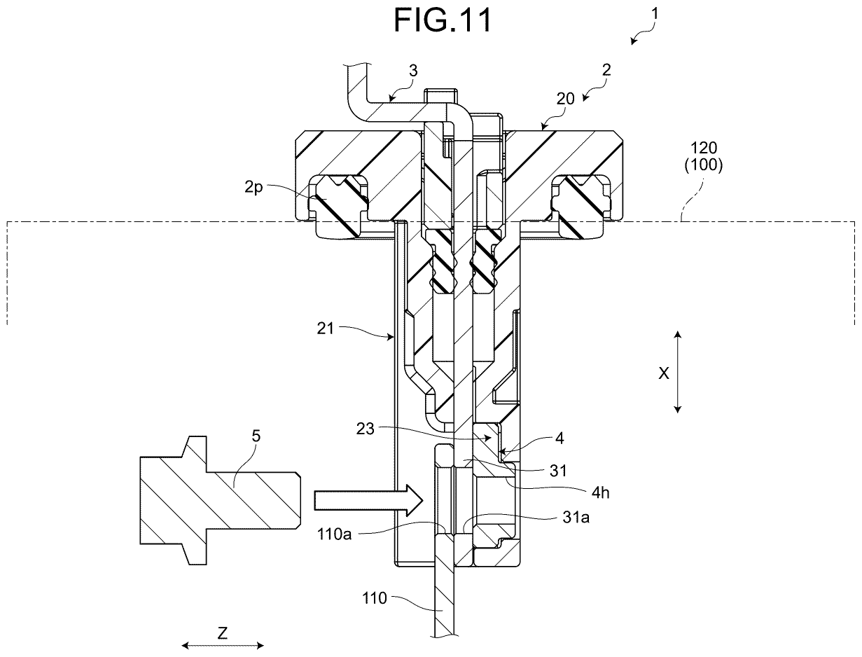

FIG. 11 illustrates the terminal block 1 fixed to a housing 120 of a first device 100. A space between the main body 20 of the housing 2 and the housing 120 is sealed by an annular surface seal 2p. The first terminal portion 31 is housed in the internal space of the housing 120. A terminal 110 of the first device 100 is disposed at a position facing the first terminal portion 31 and the nut 4. A through hole 110a of the terminal 110 faces the through hole 31a and the screw hole 4h in the third direction Z. The bolt 5 is inserted through two through holes 110a and 31a and screwed in the screw hole 4h of the nut 4.

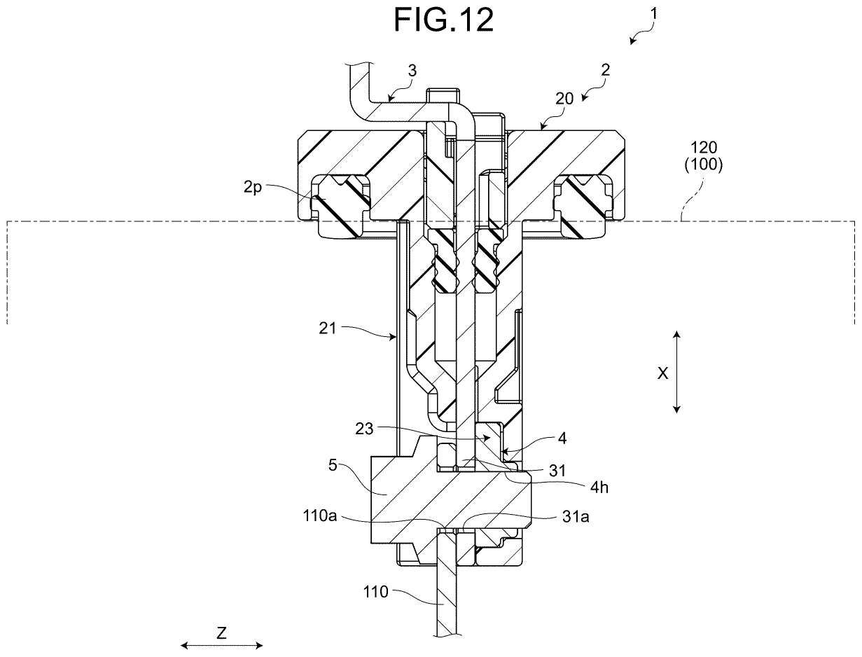

In FIG. 12, the bolt 5 fastened to the nut 4 is illustrated. As illustrated in FIG. 12, the terminal 110 and the first terminal portion 31 are co-fastened by the bolt 5 and the nut 4. The bus bar 3 is fixed to the terminal 110 and electrically connects the first device 100 and a second device.

The recess 23 in the present embodiment is configured to be able to restrict rotation of the nut 4 against torque received from the bolt 5. FIG. 13 illustrates contact parts P1, P2, P3, and P4 where the recess 23 comes into contact with the nut 4. When the bolt 5 is screwed into the nut 4, torque T1 acts on the nut 4. The torque T1 is torque around the center axis 4x of the screw hole 4h. The recess 23 can restrict the rotation of the nut 4 with the contact part P1 and P2.

The contact part P1 is a part where one locking surface 23a comes into contact with one long side 41 of the nut 4. The contact part P2 is a part where another one locking surface 23a comes into contact with another one long side 41 of the nut 4. Of the two contact parts P1 and P2, the contact part P1 is located a relatively far position from the center axis 4x.

The shape of the nut 4 in the present embodiment is a rectangle having the long side 41 and the short side 42. Accordingly, an inclination angle of the long side 41 with respect to the locking surface 23a decreases. The length of the long side 41 is, for example, larger than length defined by a standard based on the diameter of the screw hole 4h. The length of the long side 41 is, for example, larger than a reference dimension of one side defined in a standard for a square nut. In the nut 4, the length of the short side 42 may be equal to a reference dimension of one side defined in the standard for to the square nut.

The magnification of the length of the long side 41 with respect to the length of the short side 42 may be 1.1 times or may be larger than 1.1 times. This magnification may be 1.2 times, may be 1.3 times, may be 1.4 times, or may be another value.

In the terminal block 1 in the present embodiment, a contact area between the long side 41 of the nut 4 and the housing 2 at the time when the recess 23 restricts the rotation of the nut 4 can be increased. Thus, the terminal block 1 in the present embodiment can reduce a load applied to the housing 2 and stress caused in the housing 2 when the bolt 5 is screwed in the nut 4.

In the terminal block 1 in the present embodiment, the center axis 4x of the screw hole 4h is shifted in the longitudinal direction LD with respect to the center 4c of the nut 4. Therefore, the distance L3 in the first direction X from the center axis 4x to the contact part P1 can be increased. Accordingly, an inclination angle of the long side 41 with respect to the locking surface 23a decreases. For example, the inclination angle of the long side 41 with respect to the locking surface 23a is smaller compared with when the center axis 4x is disposed in the center 4c of the nut 4.

In the terminal block 1 in the present embodiment, since the distance L3 is long, reaction required at the contact part P1 for restricting the rotation of the nut 4 can be reduced. As explained above, in the terminal block 1 in the present embodiment, by using the rectangular nut 4, it is possible to reduce the load applied to the housing 2 when the bolt 5 is screwed in the nut 4.

The recess 23 in the present embodiment can further restrict the rotation of the nut 4 with the contact parts P3 and P4. The contact part P3 is a part where one facing surface 23b comes into contact with one short side 42 of the nut 4. The contact part P4 is a part where another one facing surface 23b comes into contact with another one facing surface 23b of the nut 4. Therefore, the recess 23 in the present embodiment can restrict the rotation of the nut 4 with the four contact parts P1, P2, P3, and P4.

The recess 23 in the present embodiment can also restrict the rotation of the nut 4 with respect to torque in a direction opposite to the torque T1. In this case as well, in the terminal block 1 in the present embodiment, it is possible to reduce the load applied to the housing 2 when the bolt 5 rotates with respect to the nut 4. That is, the recess 23 in the present embodiment can reduce the load applied to the housing 2 both when the nut 4 and the bolt 5 are fastened to each other and when the nut 4 and the bolt 5 are loosened.

As explained above, the terminal block 1 in the present embodiment includes the bus bar 3 including the through hole 31a, the nut 4 including the screw hole 4h, the housing 2, and the bolt 5. The housing 2 includes the holding portion 22b that holds the bus bar 3 and the recess 23. The recess 23 holds the nut 4 with the screw hole 4h caused to face the through hole 31a. The bolt 5 is screwed in the nut 4 housed in the recess 23.

The shape of the nut 4 when viewed from the direction of the center axis 4x of the screw hole 4h is the rectangle having the long side 41 and the short side 42. The screw hole 4h is disposed to be shifted to one side in the direction of the long side 41 with respect to the center 4c of the nut 4. The recess 23 includes the locking surface 23a that faces the long side 41 and restricts rotation of the nut 4. The terminal block 1 in the present embodiment can reduce the load applied to the housing 2 when the bolt 5 is screwed in the nut 4. Since the load on the housing 2 is reduced, it is possible to reduce the thickness of the housing and reduce the housing 2 in size.

The nut 4 in the present embodiment includes the rectangular main body 40 having the long side 41 and the short side 42 and the protruding portion 43 protruding from the main body 40 in the direction of the center axis 4x. The screw hole 4h is formed in the main body 40 and the protruding portion 43. The housing 2 includes the housing hole 24 opened to the recess 23. The nut 4 is housed in the recess 23 in a state in which the protruding portion 43 is inserted in the housing hole 24. With such a configuration, erroneous assembly of the nut 4 to the housing 2 is suppressed.

When the nut 4 does not include the protruding portion 43, the nut 4 can be inserted into the recess 23 in a posture different from a regular posture. For example, in the terminal block 1 in the present embodiment, the regular posture of the nut 4 is a posture in which the screw hole 4h is located on the distal end side of the support wall 21 as illustrated in FIG. 8. When the nut 4 does not include the protruding portion 43, it is likely that the nut 4 is housed in the recess 23 such that the screw hole 4h is located on a side close to the main body 20. On the other hand, the nut 4 including the protruding portion 43 can prevent such erroneous assembly.

The nut 4 including the protruding portion 43 can position the center position of torque received from the bolt 5. When the protruding portion 43 is inserted into the housing hole 24 of the housing 2, the rotation center of the nut 4 is positioned. The housing 2 may hold the protruding portion 43 to restrict the rotation of the nut 4 mainly in the contact part P1 among a plurality of contact parts.

The number of the bus bars 3 included in the terminal block 1 is not limited to three exemplified above. The numbers of the nuts 4, the bolts 5, and the recesses 23 are determined according to the number of the bus bars 3.

The contents disclosed in the embodiment explained above can be combined and executed as appropriate.

In the terminal block according to the present embodiment, the shape of the nut is the rectangle having the long side and the short side, and the screw hole is disposed to be shifted to one side in the direction of the long side with respect to the center of the nut. The recess that holds the nut includes the locking surface that faces the long side and restricts the rotation of the nut. With the terminal block of the present embodiment, by reducing the inclination angle of the long side with respect to the locking surface, there is an effect that it is possible to reduce the load applied to the housing from the nut.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar including a through hole;
a nut including a screw hole;
a housing including a holding portion that holds the bus bar, and a recess that holds the nut with the screw hole and the through hole caused to face each other; and
a bolt screwed in the nut housed in the recess, wherein
a shape of the nut is a rectangle having a long side and a short side when viewed from a direction of a center axis of the screw hole,
the screw hole is disposed to be shifted to one side along a direction of the long side with respect to a center of the nut, and
the recess includes a locking surface that faces the long side and restricts rotation of the nut.

2. The terminal block according to claim 1, wherein
the nut includes a rectangular main body having the long side and the short side, and a protruding portion protruding from the main body to the direction of the center axis,
the screw hole is formed in the main body and the protruding portion,
the housing includes a housing hole opened to the recess, and
the nut is housed in the recess in a state in which the protruding portion is inserted in the housing hole.
